(19) United States
(12) Patent Application Publication
(10) Pub. No.: US 2005/0181777 A1
(43) Pub. Date: Aug. 18, 2005

(54) Method for inputting emoticons on a mobile terminal

(75) Inventor: Eun-Kyoung Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,853

(22) Filed: Dec. 7, 2004

(30) Foreign Application Priority Data
Feb. 6, 2004 (KR) 2004-7980

(51) Int. Cl. H04M 3/00

(52) U.S. Cl. 455/418

(57) ABSTRACT

Disclosed is a method for inputting emoticons on a mobile terminal, including assigning symbols, which are commonly used to form emoticons to predetermined keys and storing the symbols in a memory of the mobile terminal; displaying symbols assigned to a key pressed by a user; and inputting a symbol selected by the user from the displayed symbols. Preferably, the assigning step should include classifying the symbols into a predetermined number of groups to correspond to a predetermined number of parts of a human face, and setting keys for selecting the respective groups of symbols. The method enables the user to rapidly input desired emoticons on the mobile terminal.

### PRIORITY

This application claims priority to an application entitled “Method for Inputting Emoticons on Mobile Terminal” filed with the Korean Intellectual Property Office on Feb. 6, 2004 and assigned Serial No. 2004-7980, the contents of which are hereby incorporated by reference.

### BACKGROUND OF THE INVENTION

1. Field of the Invention

The present invention relates to a method for inputting emoticons on a mobile terminal, and more particularly to a method for easily inputting emoticons by a combination of special characters or symbols on a mobile terminal.

2. Description of the Related Art

“Emoticons,” short for “emotion icons,” are used to convey emotion in writings by a combination of special characters, symbols or numbers (hereinafter, referred to as “symbols”). Emoticons have been developed for use in e-mail messages and chatting on personal computers. It is now common to use emoticons even in a short message inputted in a mobile terminal to express emotion or convey facial expressions (for example, smiley face \hat{ }\hat{ }). This is achieved by combining symbols provided in the terminal. However, it takes a long time to input emoticons on a mobile terminal due to a limited input means as compared to a Personal Computer (PC).

FIGS. 1A to 1C are diagrams used for explaining how to input emoticons on a mobile terminal in the prior art. FIG. 1A shows an emoticon inputted by searching for and selecting corresponding symbols in sequence. FIG. 1b shows an emoticon inputted by pressing number keys assigned to corresponding symbols in sequence. FIG. 1C shows an emoticon inputted in an emoticon input mode by a selection from a list of emoticons, which have been previously created by combining symbols and stored.

Referring to FIG. 1A, a user first selects a symbol input mode while in a text input mode. The emoticon (\hat{ }\hat{ };) depicted in FIG. 1A, is completed when the user inputs a sequence of two carats (\hat{ }) followed by a semi-colon (;). Since the carat (\hat{ }) is not included in a first group of symbols displayed at the lower part of the display window of the mobile terminal, the user has to search for a group that includes the carat (\hat{ }) using up and down keys of the mobile terminal. After inputting the carat (\hat{ }) twice, the user has to search for a symbol group that includes the semi-colon (;) again, using the up and down keys of the mobile terminal. Only when the group including the semi-colon (;) is displayed, the user then can input the semi-colon (;).

In summary, to input an emoticon the operation mode of the mobile terminal must first be changed to the symbol input mode. When a group of symbols including a desired symbol is displayed during strokes of the up and down keys, the user can select the desired symbol from the displayed group of symbols by moving a cursor using left and right keys. Such a process of searching for and selecting a symbol should be performed for every symbol comprising an emoticon.

If the user wishes to input an emoticon composed of a symbol and a number or an alphabetic character, a change of mode between the symbol input mode and the number/alphabetic character input mode will additionally be required.

The emoticon input method depicted in FIG. 1B may slightly shorten the time to select symbols, because it enables the user to select a desired symbol by pressing a corresponding number key. However, since a reduced number of symbols are displayed at a time, the user still needs to press keys repeatedly until a group of symbols including a desired symbol is displayed. When the user wishes to input an emoticon that comprises a combination of a symbol and a number or an alphabetic character, a change of mode between the symbol input mode and the number/alphabetic character input mode is required.

The conventional methods, as shown in FIGS. 1A and 1B, require too many keystrokes to input a single emoticon, which lowers the speed of input. According to the method described with reference to FIG. 1C, emoticons as combinations of symbols are pre-stored in the mobile terminal. If a large number of emoticons are stored, the user will have to repeatedly press keys to search for a desired emoticon. On the other hand, if a small number of emoticons are stored, the user will often fail to select a desired emoticon from a list of the stored emoticons. Any emoticon which is not included in the list can be inputted by the same method as these described with reference to FIG. 1A or FIG. 1B. In addition, the list of emoticons, which is displayed in a pop-up window, may interfere with the user inputting a text message.

As described above, conventional methods require too many keystrokes to input a single emoticon, thereby their rate of input is slow. As a result, it takes a long time to input a short message including an emoticon on a mobile terminal. If an incoming call or a message is received during the message inputting process, the user will have to stop the process and input his or her message again after receiving the incoming call or message.

### SUMMARY OF THE INVENTION

Accordingly, the present invention has been made to solve the above-described problems occurring in the prior art, and an object of the present invention is to provide a method for rapidly inputting emoticons on a mobile terminal.

In order to accomplish the above object of the invention, there is provided a method for inputting emoticons on a mobile terminal, which includes assigning commonly used symbols to form emoticons to predetermined keys and storing the symbols in a memory of the mobile terminal; displaying symbols assigned to a key pressed by a user; and inputting a symbol selected by the user from the displayed symbols. Preferably, the assigning step should include classifying the symbols into a predetermined number of groups to correspond to a predetermined number of parts of a human face; and setting keys for selecting the respective groups of symbols.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1B are views used for describing a method for inputting emoticons in the prior art; (PLEASE ADD AN INSCRIPTION “PRIOR ART”)

FIG. 2 is a flow chart of a process of inputting an emoticon according to the present invention;

FIG. 3 is a table showing an exemplary classification of symbols for forming upright emoticons according to one embodiment of the present invention;

FIG. 4 is a state diagram for inputting upright emoticons in accordance with one embodiment of the present invention;

FIGS. 5A to 5E are views used for describing a method for inputting upright emoticons in accordance with one embodiment of the present invention;

FIG. 6 is a table showing an exemplary classification of symbols for forming sideways emoticons according to another embodiment of the present invention;

FIG. 7 is a state diagram for inputting sideways emoticons in accordance with an embodiment of the present invention; and

FIGS. 8A to 8G are views used for describing a method for inputting sideways emoticons in accordance with one embodiment of the present invention.

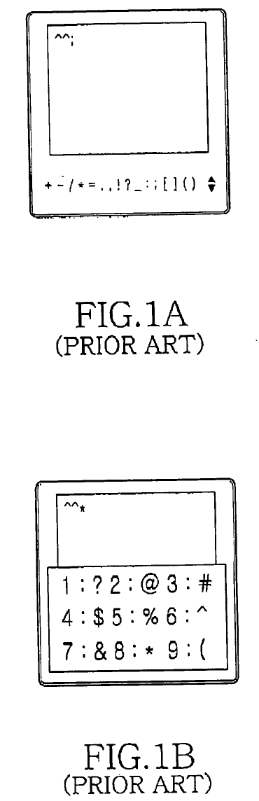

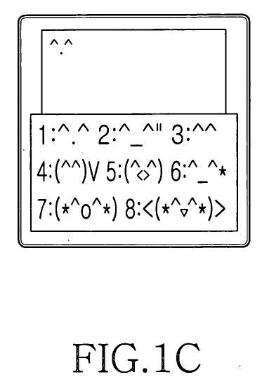

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

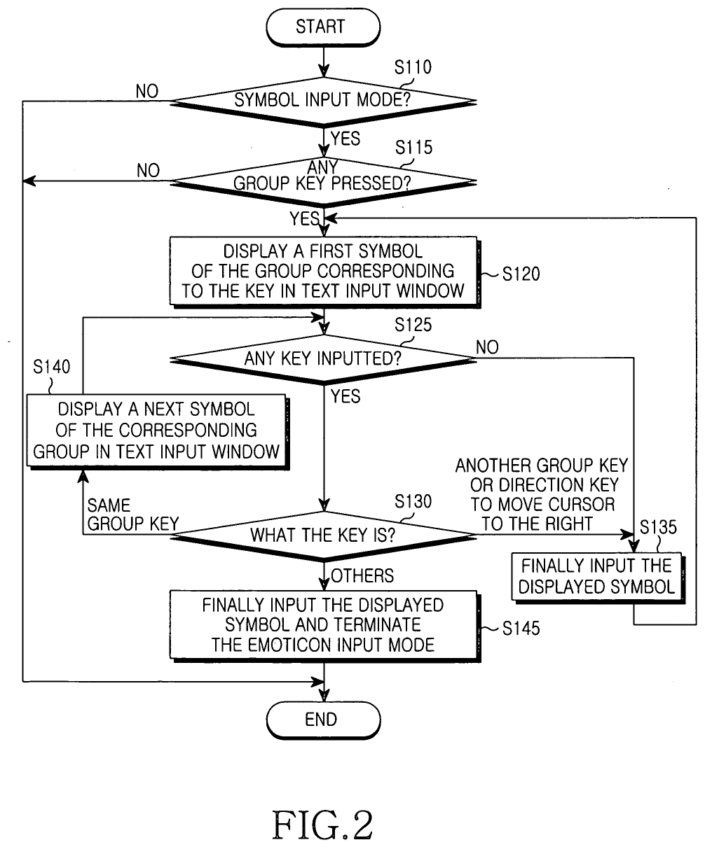

FIG. 2 is a flow chart showing a process of inputting an emoticon according to the present invention. Referring to FIG. 2, symbols which are commonly used to form emoticons are stored in a memory (not shown) of a mobile terminal to correspond to predetermined keys. Since emoticons are typically used to represent human facial expressions, each one is formed by a combination of symbols with face-like patterns. For example, an upright emoticon (\hat{ }_\hat{ }) can be formed by a sequence of the symbols (, \hat{ }, ₁₃ , \hat{ }and), which represent a left side of a face, a left arched eyebrow, a nose or a mouth, a right arched eyebrow and a right side of the face, respectively. Certain symbols may be omitted when forming upright emoticons. A sideways emoticon :-) that looks like a smiley face when read sideways can be formed by a sequence of a colon, a hyphen and a right-parenthesis which represent the eyes, the nose and the mouth of a smiley face. Certain symbols can be omitted even in sideways emoticons.

Symbols, characters, and numbers that can be used to form upright emoticons are classified into three groups: a first group representing the left part of a face, for example, (, \hat{ }and @; a second group representing the center of the face, for example, _, . and o; and a third group representing the right part of the face, for example, ), \hat{ }, @, /, ; and '. Also, three different keys are set to correspond respectively to the three groups of symbols, characters and numbers (hereinafter “symbols”). For example, it is possible to set a lower left key, e.g., *, on the keypad of the mobile terminal to select the first group of symbols representing the left part of the face, a lower center key, e.g., 0, to select the second group of symbols representing the center of the face, and a lower right key, e.g., #, to select the third group of symbols representing the right part of the face.

Symbols that can be used to form sideways emoticons are also classified into three groups: a first group representing the upper part of the face, for example, <, 8 and B; a second group representing the middle part of the face, for example, -, * and •; and a third representing the lower part of the face, for example, (,), > and D. Also, three different keys are set to correspond respectively to the three groups of symbols. For example, it is possible to set a lower left key, e.g., *, on the keypad of the mobile terminal to select the first group of symbols representing the upper part of the face, a lower center key, e.g., 0, to select the second group of symbols representing the middle part of the face, and a lower right key, e.g., #, to select the third group of symbols representing the lower part of the face.

When the mobile terminal enters the symbol input mode in step S110, , and any of the above described group of keys is pressed in step S115, the mobile terminal performs a series of steps S120-145 as follows: First, in step S120, the mobile terminal displays a first symbol included in the group corresponding to the pressed key in a text input window. At this time, no separate pop-up window is generated to display the group of symbols. The mobile terminal displays the first symbol in the text input window based on data stored in its memory. If in step S125 any key is additionally pressed during the display of the first symbol, the mobile terminal will determine what the key is in step S130.

If the key pressed at step S125 is the same as that pressed at step S115, i.e., the previously pressed key, in step S140, the mobile terminal will display a second symbol of the group corresponding to the key.

If the key pressed at step S125 is another group key or a direction key for moving a cursor to the right, in step S135 the mobile terminal will input the displayed first symbol and the process will return to step S120. In other words, the mobile terminal will display a first symbol of the other group corresponding to the other group key pressed at step S125 and will proceed with steps subsequent to S120.

If a key other than the group keys is pressed at step S125, in step S145 the mobile terminal will input the displayed first symbol and will then cancel the symbol input mode to deactivate the input of an emoticon.

If no key is pressed for a predetermined period of time at step S125, in step S135, the mobile terminal will input the displayed first symbol and will proceed with the next step.

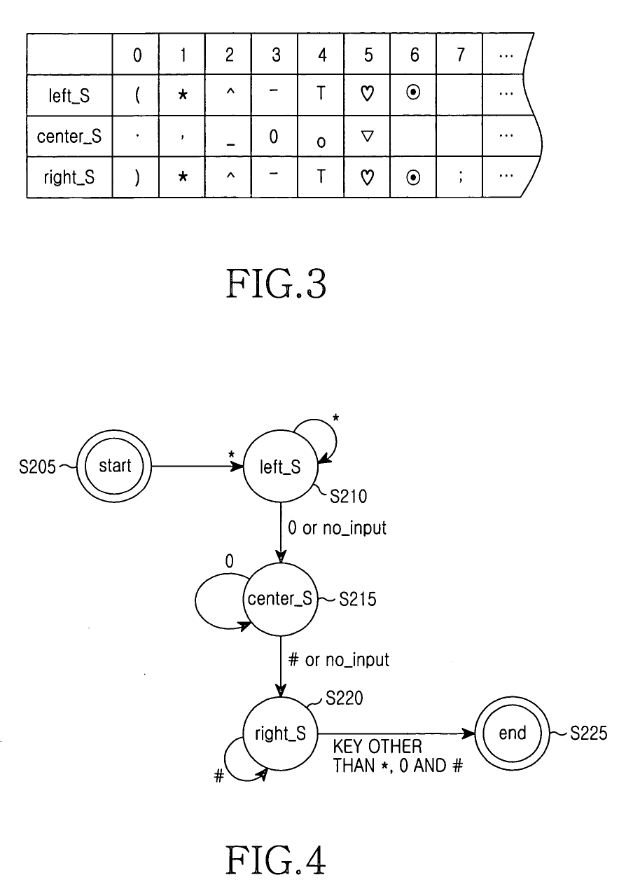

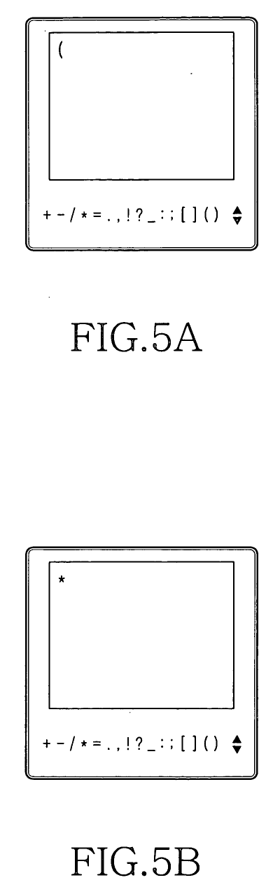

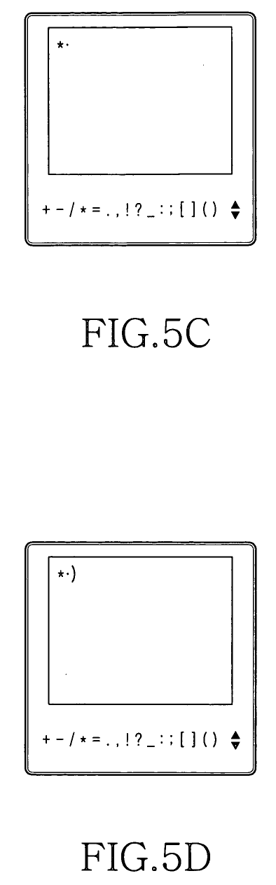

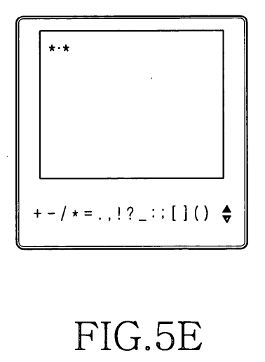

FIG. 3 is a table showing an exemplary classification of symbols for forming upright emoticons according to the present invention. FIG. 4 is a state diagram and FIGS. 5A to 5E are views showing a method for inputting an upright emoticon according to the present invention. Referring to FIG. 3, symbols that represent the left part, center and right part of a face are grouped into left_S, center_S and right_S groups. In the table of FIG. 3, the left_S group includes symbols representing the left part of the face; the center_S group includes symbols representing the center of the face; and the right_S group includes symbols representing the right part of the face. Preferably, the lower left key * on the keypad can be set as a key for selecting the symbols of the left_S group. The lower center key 0 of the keypad can be set as a key for selecting the symbols of the center_S group. Also, the lower right key # can be set as a key for selecting the symbols of the right_S group.

FIG. 4 is a view showing a method for inputting an upright emoticon by pressing the group of keys listed in the table of FIG. 3 in the symbol input mode. The circles in FIG. 4 represent the operational states of the mobile terminal. Step S205 refers to the start of the emoticon input mode; step S210 refers to the state for calling the symbols of the left_S group; step S215 refers to the state for calling the symbols of the center_S group; step S220 refers to the state for calling the symbols of the right_S group; and step S225 refers to the termination of the emoticon input mode.

The method for inputting an upright emoticon according to the present invention will be explained in detail with reference to FIG. 4. If in step S205 the user presses the key * in the emoticon input mode which is a mode waiting for an input of a group key in the symbol input mode, in step S210 the mobile terminal will change its operational state to call the symbols included in the left_S group and will display those symbols one after another in a text input window. In other words, the mobile terminal displays the symbols corresponding to the left part of a face one after another in the text input window. Subsequently, the mobile terminal determines whether the user has selected any displayed symbol. In step S215 the mobile terminal changes its operation state to call the symbols included in the center_S group when another group key (“0”) is pressed or there is no additional input of a key for a predetermined period of time.

The mobile terminal displays the symbols of the center_S group, which correspond to the center of the face, one after another in the text input window (S215). Subsequently, the mobile terminal determines whether the user has selected any displayed symbol. In step S220 the mobile terminal changes its operational state to call the symbols included in the right_S group when another group key (“#”) is pressed or there is no additional input of a key for a predetermined period of time.

At step S220, the mobile terminal displays the symbols of the right_S group, which correspond to the right part of the face, one after another in the text input window. Subsequently, the mobile terminal determines whether the user has selected any displayed symbol. In step S225 the mobile terminal terminates the emoticon input mode when the user inputs any key other than the group keys *, 0 and #.

FIG. 5A shows the display of a first symbol (of the left_S group as shown in the table of FIG. 3 when the user presses the group key * for selecting the symbols representing the left part of the face in the symbol input mode. FIG. 5B shows the display of a second symbol * of the left_S group listed in the table of FIG. 3 when the user presses the group key * again. If there is no additional keystroke for a predetermined period of time or if another group key, e.g., 0 for selecting the symbols representing the center of the face, is pressed, the second symbol * of the left_S group will be finally inputted and a first symbol • of the center_S group as shown in the table of FIG. 3 will be displayed next to the symbol * in the text input window. FIG. 5C shows the display of the first symbol • of the center_S group.

If there is no additional keystroke for a predetermined period of time or if another group key, e.g., # for selecting the symbols representing the right part of the face, is pressed, the symbol representing the center of the face will be finally inputted and a first symbol ) of the right_S group as listed in the table of FIG. 3 will be displayed next to the two inputted symbols * and •. FIG. 5D shows the display of the first symbol) of the right _S group.

If the user again presses the group key # for selecting the symbols representing the right part of the face, a second symbol * of the right_S group, listed in the table of FIG. 3, will be displayed in the text input window. FIG. 5E shows the display of the second symbol * of the right_S group.

No separate pop-up window is generated to display any group of symbols. As shown in FIGS. 5A through 5E, selected symbols are displayed in the text input window that displays a text message being inputted by the user. The symbols displayed at the lower part of the window in FIGS. 5A through 5E are not those included in any group selected from the left_S, center_S and right_S by pressing a group key. The display of symbols at the lower part of the window is merely to indicate that the mobile terminal is in the mode of inputting a symbol for forming an emoticon, by pressing a group key. Accordingly, the symbols at the lower part of the window as shown in FIGS. 5A to 5E can be displayed in any other form according to the symbol input method available in the mobile terminal.

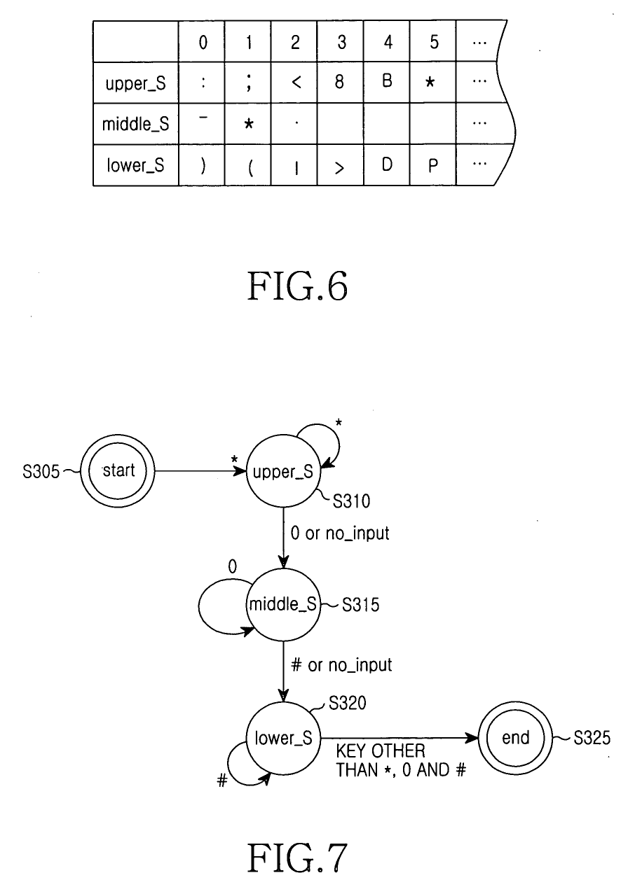

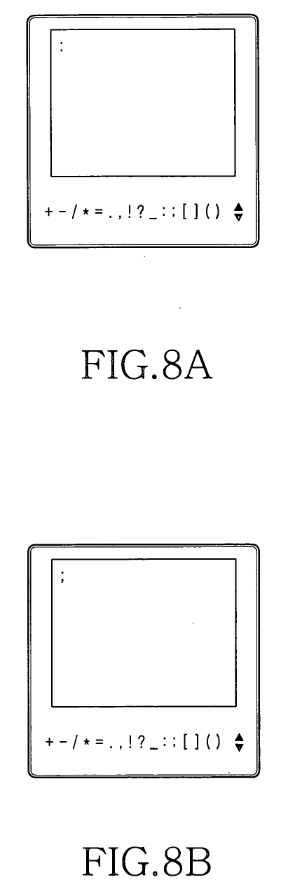

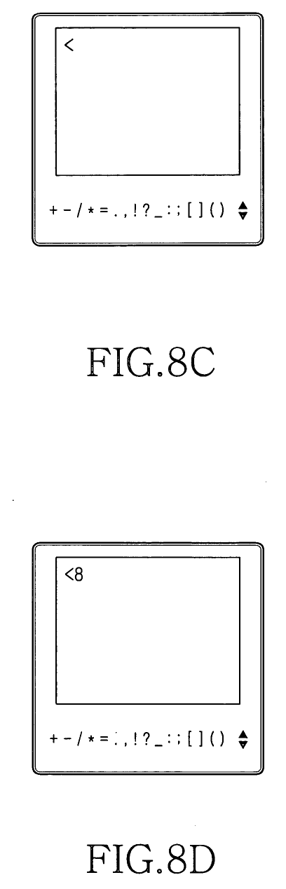

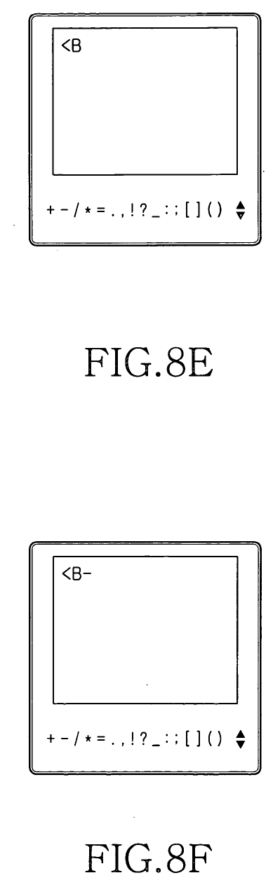

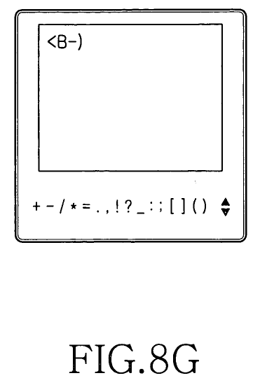

FIG. 6 is a table showing an exemplary classification of symbols for forming sideways emoticons according to another embodiment of the present invention. FIG. 7 is a state diagram and FIGS. 8A to 8G are views showing a method for inputting a sideways emoticon according to the present invention.

Referring to FIG. 6, symbols that represent the upper, middle and lower parts of a face are grouped into upper_S, middle_S and lower_S groups. In FIG. 6, the upper_S group includes symbols representing the upper part of the face; the middle_S group includes symbols representing the middle part of the face; and the lower_S group includes symbols representing the lower part of the face. Preferably, the lower left key, e.g., *, on the keypad can be set as a key for selecting the symbols of the upper_S group. The lower center key, e.g., 0, of the keypad can be set as a key for selecting the symbols of the middle_S group. Also, the lower right key, e.g., #, can be set as a key for selecting the symbols of the lower_S group.

FIG. 7 is a state diagram showing a method for inputting a sideways emoticon by pressing the above group keys in the symbol input mode. The circles in FIG. 7 represent the operational states of the mobile terminal. Step S305 refers to the start of the emoticon input mode; step S310 refers to the state for calling the symbols of the upper_S group; step S315 refers to the state for calling the symbols of the middle_S group; step S320 refers to the state for calling the symbols of the lower_S group; and step S325 refers to the termination of the emoticon input mode.

The method for inputting a sideways emoticons according to the present invention will be explained in detail with reference to FIG. 7. If, in step S305 the user presses the key * in the emoticon input mode which is a mode waiting for an input of a group key in the symbol input mode, in step S310 the mobile terminal will change its operational state to call the symbols included in the upper_S group and will display those symbols, corresponding to the upper part of a face, one after another in the text input window. Subsequently, the mobile terminal determines whether the user has selected any displayed symbol. In step S315, the mobile terminal changes its operation state to call the symbols included in the middle_S group when another group key (“0”) is pressed or there is no additional input of a key for a predetermined period of time.

In step S315, the mobile terminal displays the symbols of the middle_S group, which correspond to the middle part of the face, one after another in the text input window. Subsequently, the mobile terminal determines whether the user has selected any displayed symbol. In step S320, the mobile terminal changes its operational state to call the symbols included in the lower_S group when another group key (“#”) is pressed or there is no additional input of a key for a predetermined period of time.

At S320, the mobile terminal displays the symbols of the lower_S group, which correspond to the lower part of the face, one after another in the text input window. Subsequently, the mobile terminal determines whether the user has selected any displayed symbol. In step S325 the mobile terminal terminates the emoticon input mode when the user inputs any key other than the group keys *, 0 and #.

FIG. 8A shows the display of a first symbol : of the upper_S group as shown in the table of FIG. 6, when the user presses the group key * for selecting the symbols representing the upper part of the face in the symbol input mode. FIG. 8B shows the display of a second symbol ; of the upper_S group listed in the table of FIG. 6 when the user presses the group key * again. FIG. 8C shows the display of a third symbol < of the upper_S group when the user presses the group key * once again. If for a predetermined period of time the user presses no key or a direction key to move a cursor, the third symbol < will be finally inputted. If the user presses the same group key * again, a fourth symbol 8 of the upper_S group listed in the table FIG. 6 will be displayed next to the inputted symbol < in the text input window. FIG. 8D shows the display of the fourth symbol 8 in the text input window. If the user presses the group key * again, a fifth symbol B of the upper_S group representing the upper part of the face will be displayed in the text input window. FIG. 8E shows the display of the fifth symbol B next to the symbol < in the text input window.

If there is no additional keystroke for a predetermined period of time or if another group key is pressed, e.g., 0, used for selecting the symbols representing the middle part of the face , the symbol B will finally be inputted to represent the upper part of the face and a first symbol - of the middle_S group listed in the table of FIG. 6 will be displayed next to the two inputted symbols < and B in the text input window. FIG. 8F shows the display of the first symbol - of the middle_S group in the text input window.

If there are no additional keystrokes for a predetermined period of time or if another group key is pressed, e.g., # for selecting the symbols representing the lower part of the face, the symbol - will finally be inputted to represent the middle part of the face and a first symbol) of the lower_S group listed in the table of FIG. 6 will be displayed next to the three inputted symbols <, B and -. FIG. 8G shows the display of the first symbol) of the lower_S group in the text input window.

No separate pop-up window is generated to display any group of symbols. As shown in FIGS. 8A through 8Q selected symbols are displayed in the text input window that displays a text message being inputted by the user. The symbols displayed at the lower part of the window in FIGS. 8A through 8G are not those included in any group selected from the upper_S, middle_S and lower_S group by pressing an appropriate group key. The display of symbols at the lower part of the window is merely to indicate that the mobile terminal is in the mode of inputting a symbol for forming an emoticon by pressing a group key. Accordingly, the symbols at the lower part of the window in FIGS. 8A to 8G can be displayed in any other form according to the symbol input method available in the mobile terminal.

As described above, the present invention classifies symbols intuitively associated with certain parts of a human face into groups, for example three, and enables the user to quickly and easily input an emoticon by a combination of corresponding symbols. Keys are set to select and display the respective groups of symbols in the symbol input mode. There is no need to change the mode to a separate emoticon input mode, which improves user convenience. No pop-up window is generated to display any group of symbols. The user can select each symbol displayed in the text input window to be finally inputted to form an emoticon. Since emoticons can be inputted in the symbol input mode, any symbol which is not included in the classified groups of symbols for forming emoticons can also be inserted to form an emoticon. Accordingly, the present invention enables the user to rapidly input desired emoticons on the mobile terminal.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

1. A method for inputting emoticons on a mobile terminal, the method comprises the steps of:
assigning symbols, which are frequently used to form emoticons, to predetermined keys and storing the symbols in a memory of the mobile terminal;
displaying symbols assigned to one of the predetermined keys when a predetermined key is pressed by a user; and
inputting a symbol selected by the user from the displayed symbols.

2. The method according to claim 1, wherein said displaying and inputting steps are repeated in response to any of said predetermined keys being inputted.

3. The method according to claim 1, wherein said assigning step further includes the steps of:
classifying the symbols for forming emoticons into a predetermined number of groups corresponding to a predetermined number of sections of a human face; and
setting keys for selecting the classified groups of symbols.

4. The method according to claim 3, wherein said classifying step divides the human face into a left section, a center section and a right section, and classifies the symbols into a first group representing the left section, a second group representing the center section and a third group representing the right section.

5. The method according to claim 4, wherein said setting step sets a key on a left side of a keypad of the mobile terminal as a first group key for selecting the first group, a key at a center of the keypad as a second group key for selecting the second group and a key on a right side of the keypad as a third group key for selecting the third group.

6. The method according to claim 3, wherein said classifying step divides the human face into an upper section, a middle section and a lower section and classifies the symbols into a fourth group representing the upper section, a fifth group representing the middle section and a sixth group representing the lower section.

7. The method according to claim 6, wherein said setting step sets a key on a left side of a keypad of the mobile terminal as a fourth group key for selecting the fourth group, a key at a center of the keypad as a fifth group key for selecting the fifth group and a key on a right side of the keypad as a sixth group key for selecting the sixth group.

8. A method for inputting emoticons on a mobile terminal, the method comprising the steps of:
assigning a symbol which consists of at least one character to at least one key of a keypad;
storing said symbol related to said key in a memory of said terminal;
monitoring whether the key is input by a user; and
inputting a symbol assigned to the key input by the user.

9. The method according to claim 8, further comprising displaying a symbol assigned to the key input by the user.

10. A method for inputting emoticons on a mobile terminal, the method comprising the steps of:
receiving at least one character as a symbol to form an emoticon;
assigning said symbol to a predetermined key; and
storing the symbol and the key in association with each other.
